(19) United States
(12) Patent Application Publication
(10) Pub. No.: US 2005/0070130 A1
(43) Pub. Date: Mar. 31, 2005

(54) Card connector

(76) Inventors: Qisheng Zheng, Kunsan (CN); Shaoping Du, Kunsan (CN); Bo Chen, Kunsan (CN)

Correspondence Address: WEI TE CHUNG;FOXCONN INTERNATIONAL, INC., 1650 MEMOREX DRIVE, SANTA CLARA, CA, 95050, US

(21) Appl. No.: 10/949,039

(22) Filed: Sep. 24, 2004

(30) Foreign Application Priority Data
Sep. 26, 2003 (TW) 92217368

(51) Int. Cl. H01R 12/00

(52) U.S. Cl. 439/62

(57) ABSTRACT

An electrical card connector (100) includes a base member (1), a cover (2) and a hinge (3) for pivotally connecting the cover with the base. The base member includes an insulative housing (11) and a plurality of conductive contacts received in the housing. The cover includes a top cover (21) and a bottom cover (22). The top cover includes a pair of blades (26), with a pinhole (261) positioning on the blade for engaging with the hinge. The base member includes a pair of pivoting portions (1131). Each pivoting portion defines an engaging groove for engaging with the hinge. Each engaging groove defines an upper exposed opening.

### BACKGROUND OF THE INVENTION

1. Field of the Invention

This invention generally relates to an electrical connector and more particularly, to a card connector for interconnecting an electrical card and a printed circuit board.

2. Description of the Prior Art

Conventional electrical card connector used in portable electronic devices for connecting an electrical card to a printed circuit board includes an insulative housing, a plurality of electrodes or contacts exposed in the housing for electrically connecting with circuit traces of the card and a card-protecting shell permitting the card to insert and remove therefrom and preventing the card from any exterior hazards. U.S. Pat. No. 5,984,707 discloses a card connector including an insulative base with a plurality of electrical contacts and an insulative cover with a receiving room. The base includes a pair of opposite blades with a pair of fixing holes. The cover includes a pair of small insulative fixing nods projecting toward each other for engaging with the fixing holes of the insulative base, thereby being pivotally connected to the base. However, the structure arises a series of problems. A resistant force between the base and the cover is relatively weak only through engaging of the tiny insulative fixing nods and the fixing holes. More times of open and close the cover or incorrectly using, the fixing nods tend to break away from the fixing holes of the base, thereby damaging the card connector. The life span of the card connector becomes short.

Hence, an improved card connector is desired to overcome the foregoing shortcomings.

### BRIEF SUMMARY OF THE INVENTION

It is an object of the present invention to provide a card connector which has a good pivoting structure and a relatively long life-span.

In order to attain the object above, an electrical card connector according to the present invention comprises a base member, a cover and a hinge for pivotally connecting the cover to the base. The base member includes an insulative housing and a plurality of electrically conductive contacts held in the housing. The insulative housing includes a rear wall. A pair of pivoting portions extend from the rear wall. Said pivoting portions define a pair of substantially cylindrical engaging groove for engaging the hinge. Said groove defines an upper exposed opening. A width of the opening is narrower than a diameter of the groove, thereby securely engaging the hinge. The cover includes a top cover and a bottom cover. The bottom cover defines a opening on a rear portion thereof for receiving the base member. Said opening includes a pair of blades, with a pair of pinholes positioning on the blades for engaging with the hinge.

Other objects, advantages and novel features of the invention will become more apparent from the following detailed description of the present embodiment when taken in conjunction with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is a perspective view of a card connector according to the present invention;

FIG. 2 is an exploded view of FIG. 1;

FIG. 3 is a partially assembled view of the card connector of FIG. 2;

FIG. 4 is a view similar to FIG. 3 but taken from another perspective;

FIG. 5 is an exploded view of FIG. 4; and

FIG. 6 is a cross-section view taken from A-A of FIG. 4.

### DETAILED DESCRIPTION OF THE INVENTION

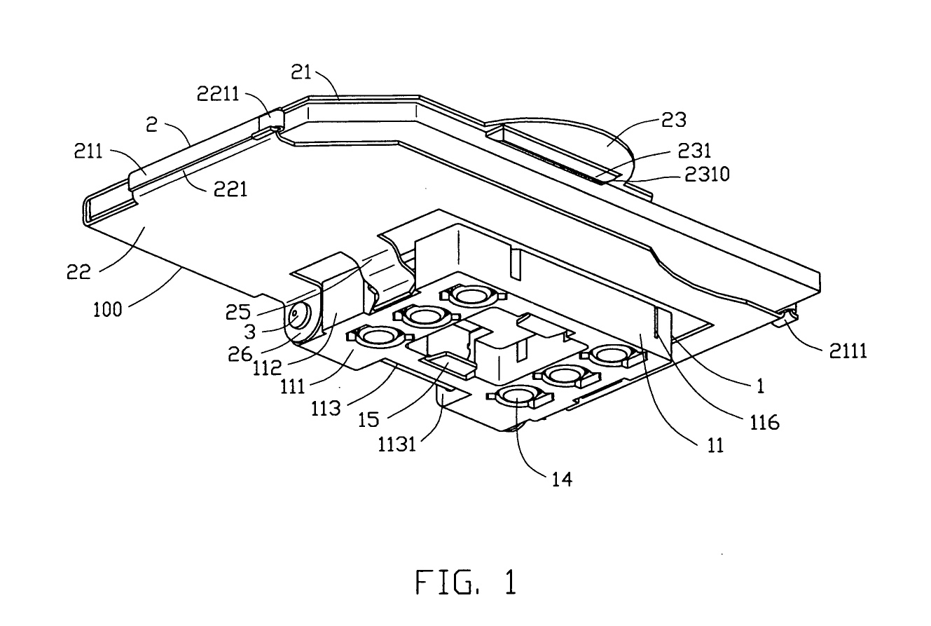

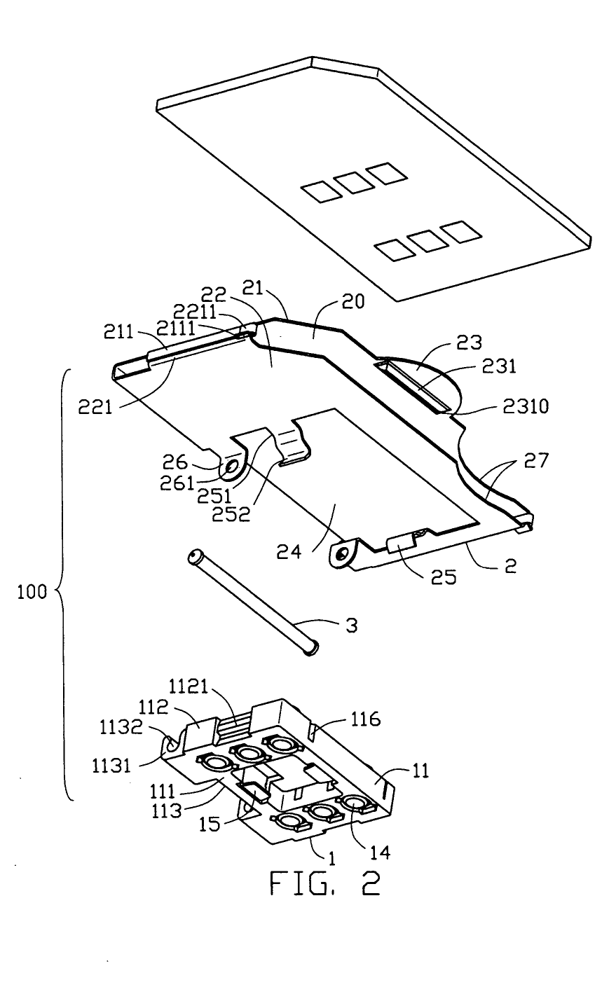

Referring to FIGS. 1-2, a card connector according to the present invention includes a base member 1, a cover 2 for receiving an IC card (not labeled) and a hinge 3 for interconnecting the base member 1 and the cover 2.

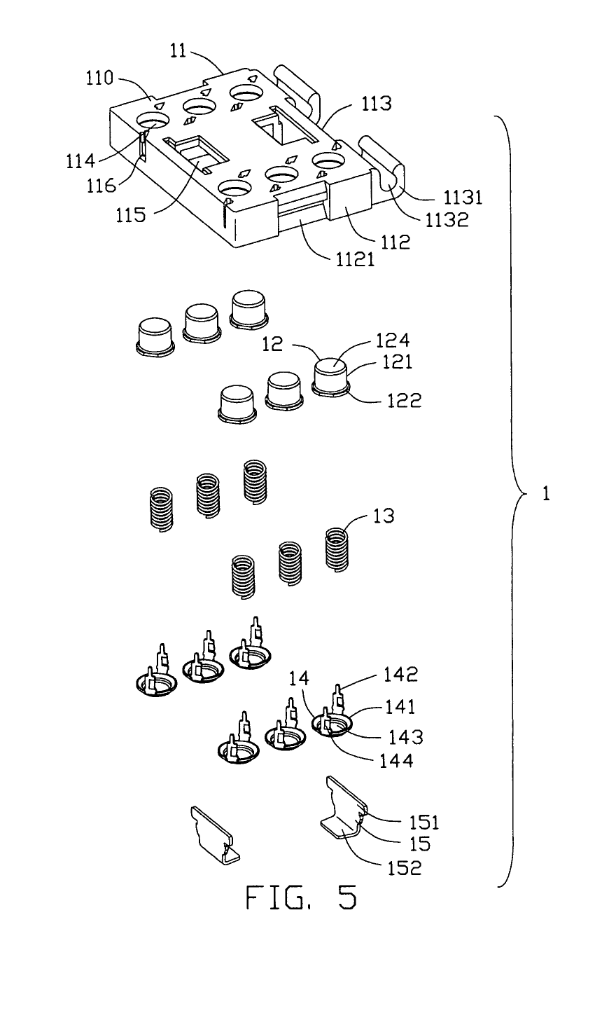

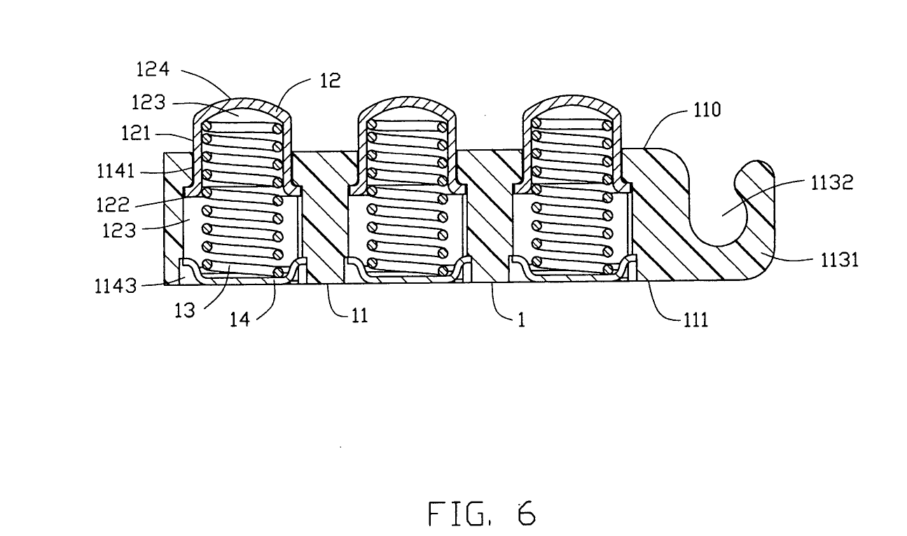

Referring to FIGS. 5-6, the base member 1 includes a substantially rectangular insulative housing 11, a plurality of conductive contacts received in the housing 11 and a pair of latching tabs 15. The insulative housing 11 comprises an upper wall 110, a lower wall 111, a pair of side walls 112 and a rear wall 113. The housing 11 defines two rows of through holes 114 through the upper and lower walls 110, 111 adjacent to corresponding side walls 112. A pair of latching recesses 115 are positioned in a generally middle portion of the housing 11. Each side wall 112 defines a concaved resistant cavity 1121 adjacent to a middle portion thereof. A pair of pivoting portions 1131 extend rearward and upwardly from opposite side portions of the rear wall 113. An upwardly exposed engaging groove 1132 downwardly depresses from an upper surface (not labeled) of each pivoting portion 1131 and is parallel to the rear wall 113, thereby forming an upper opening (not labeled). A width of the opening of the engaging groove 1132 is narrower than diameter of an inner periphery of the engaging groove 1132. The housing 11 includes a top step 1141 inwardly and radially projecting into a top portion of each through hole 114. The housing 11 defines a recess communicating with a bottom portion of each through hole 114. The recess has the same axis as each through hole 114 and has a diameter larger than that of each through hole 114, thereby forming a bottom step 1143 in the bottom portion of the each through hole 114. The housing 11 has a plurality of pairs of parallel fixing slots 116 through the upper and lower surfaces 110, 111 and each pair of fixing slots 116 are position at opposite sides of each through hole 114.

The conductive contacts received in the housing 11 comprise contact terminals 12, compression springs 13 and retaining terminals 14. Each contact terminal 12, as best shown in FIG. 5, includes a sleeve body section 121 defining a receiving cavity 123 therein for receiving an upper portion of the compression spring 13 and a convex contact section 124 covering at top of the body section 121 for contacting with appropriate circuit traces of the card. A mounting flange 122 extends perpendicularly and outwardly from a lower periphery of the body section 121 and cooperates with the top step 1141 of the housing 11.

The retaining terminal 14 includes a base portion 141 and a pair of symmetrical fixing beams 142 extending upwardly from the base portion 141. The base portion 141 has a substantially cap-shaped configuration and (not labeled) defines an upwardly exposed hollow space 143 for abutting against a lower end of the compression spring 13. The base portion 141 has a soldering section (not labeled) at opposite surface relative to the hollow space 143 for soldering to a PCB (not shown). Each fixing beam 142 has an outwardly projecting tuber 144 formed thereon corresponding to the fixing slot 116 of the housing 11.

The compression spring 13 is received in the through hole 114 of the housing 11. The lower end of the spring 13 abuts against the hollow space 143 of the retaining terminal 14 and the upper end of the compression spring 13 extends into the body portion 121 abutting against the inner surface of the receiving cavity 123.

Each latching tab 15 includes a hook portion 151 latching in the latching recess 115 of the housing 11 and a soldering portion 152 perpendicularly extending from a lower end of the hook portion 151 for soldering to the PCB.

Referring to FIG. 2, the cover 2 includes a top cover 21 and a bottom cover 22. A pair of first lateral plates 211 downwardly extend and depend from opposite edges of the top cover 21. A pair of second lateral plates 221 upwardly extend and depend from opposite edges of the bottom cover 22. The first lateral plates 211 abut against the second lateral plates 221. A first bending portion 2211 outwardly and rearward bend from a front edge of each second lateral plate 221 for covering the first lateral plate 211. A second bending portion 2111 outwardly bend from a bottom end of the first lateral plate 211 for latching with the first bending portion 2211, therefore, the top cover 21 and the bottom cover 22 mount together to define a receptacle 20 for receiving the card. A front nose portion 23 extends forwardly from a front edge of the top cover 21 and an elongate rib 231 is downwardly formed on the front nose portion 23. A guiding incline 2310 is formed on the rib 231 adjacent to the receptacle 20 for guiding the card into the receptacle 20. The bottom cover 22 has a opening 24 and a pair of engaging sheets 25 extending downwardly to each other from opposite edges of the opening 24. Each engaging sheet 25 includes an elastic portion 251 extending downwardly and a snapping portion 252 extending from a distal free end of the elastic portion 251 for securely grasping the base member 1 therebetween. The bottom cover 22 has a pair of blades 26 extending perpendicularly and downwardly from the bottom cover 22. Each blade 26 has a pinhole 261 engages with an end of the hinge 3. The cover 2 defines a pair of cutouts 27 on the top cover 21 and the bottom cover 22 for facilitating to extract the inserted card.

The hinge 3 has a substantially cylinder-shaped configuration. The hinge 3 is assembled in the pinholes 261 of the cover 2 and cooperates with pivoting portions 1131 of the housing 1. Two ends of the hinge 3 are staved and can not break away from the pinholes 261. The width of the upper opening of the engaging groove 1132 is narrower than diameter of the inner periphery of the engaging groove 1132 so that the hinge can engage with the base member 1 well, whereby the cover 2 is pivotally mounted on the base member 1 and can pivotally move toward and away from the base member 1.

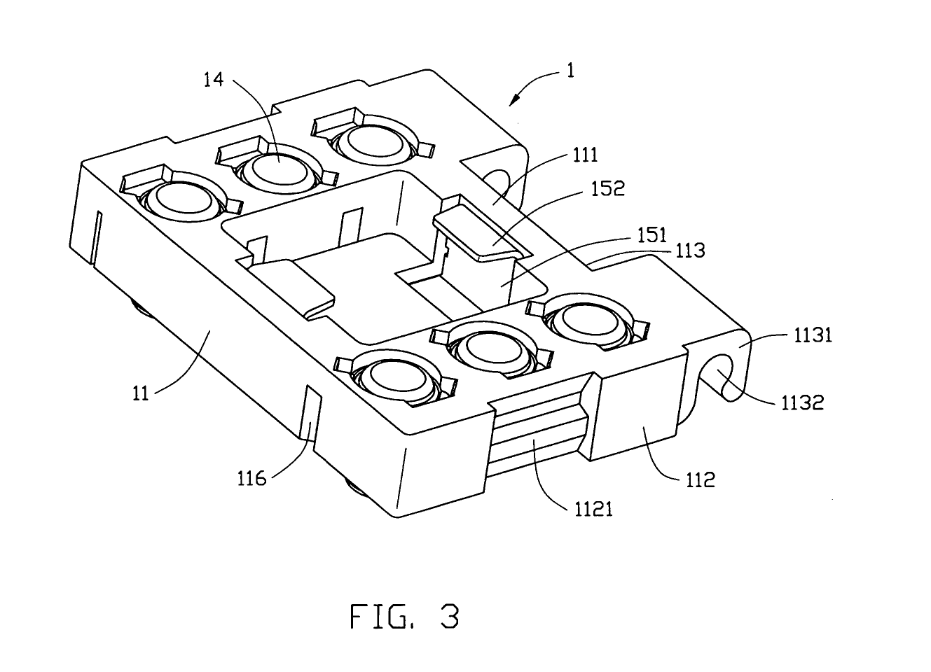

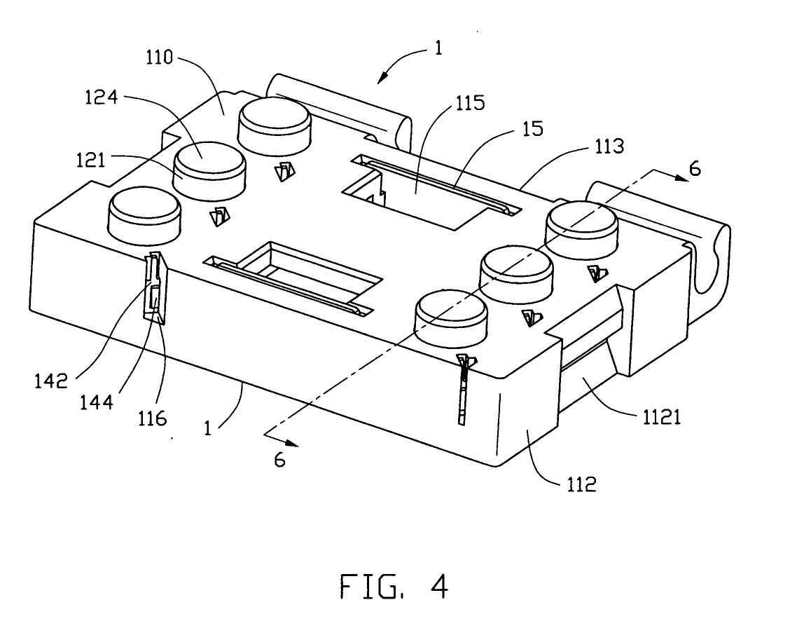

Referring to FIGS. 1-6, in assembly, the contact terminals 12 are installed into the through holes 114 of the housing 11 from the lower surface 111 of the housing 11. The sleeve body section 121 with the convex contact section 124 of each contact terminal 12 projects above the upper surface 110 of the housing 11. The mounting flanges 122 of the contact terminals 12 engage with corresponding top steps 1141 of the through holes 114. The compression springs 13 are received in the through hole 114 of the housing 11 and the upper end of each compression spring 13 extends into the receiving cavity 123 of the contact terminal 12. The retaining terminals 14 are fixed to the bottom steps 1143 of the housing 11 from the lower surface 111 of the housing 11. The fixing beams 142 with the tubers 144 of the fixing terminals 12 are inserted into the fixing slots 116 of the housing 11 for fixing the retaining terminals 14 to the housing 11. Then in assembly of the cover 2 to the base member 1, the hinge 3 is seated into the pinholes 261 of the blades 26 of the bottom cover 22 and moves into the distal ends of the pivoting portions 1131 of the housing 11. The engaging portions 252 of the engaging sheet 25 snap corresponding resistant cavities 1121 for securely grasping the base member 1 therebetween. The cover 2 is captured onto the base member 1 via snapping between the engaging sheets 25 and the resistant cavities 1121.

In using, the card 4 is inserted into the receptacle 20 of the cover 2. The card exerts a downwardly depressing force on the contact terminals 12 and the compression springs 13 and at the same time the card gets an upwardly counterforce from them. The card is retained by inner surface of the top cover 21 and cannot move in top-to-bottom directions upwardly and downwardly. Meanwhile the card is retained by the rib 231 of the top cover 21 and cannot move in front-to-rear directions forwardly and backwardly. The card sits the reading position securable the connection between the card and the contact terminals 12. Requiring the card extracted from the receptacle 20 of the cover 2, the engaging sheets 25 free from the resistant slots 1121 and the cover 2 pivots away the base 1. When the card separates with the contact terminals 12, the contact terminals 12 and the compression springs 13 comeback and the force and counterforce disappeared. The card is remained on inner surface of the bottom cover 22 and relaxed to the rib 231 of the top cover 21 so as to the card extracted from the cut out 27 along the inner surface of the bottom cover 22 easily.

Comparing to prior arts, an card connector according to the present invention has relatively good resistant structure through providing a hinge 3, a pair of pinholes 261 of corresponding blades 26 of the base member 1 and the engaging grooves 1132 of the pivoting portions 1131 of the cover 2. Furthermore, the card connector occupies a relatively small room through providing the blades 26 on the opening 24 of the cover.

It is to be understood, however, that even though numerous, characteristics and advantages of the present invention have been set fourth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

1. A card connector adapted for connecting an electrical card with a printed circuit board comprising:
a base member including an insulative housing and a plurality of conductive contacts held in the housing, said housing comprising a rear wall and a pivoting portion extending from the rear wall, an engaging groove being defined in the pivoting portion;
a cover defining a receptacle for receiving an electrical card therein and a pair of blades positioned on a rear portion thereof, said blades including a pair of pinholes; and
a hinge being inserted into the engaging groove of the pivoting portion and the pinholes of the blades of the cover for hinging the cover to the base member.

2. The card connector according to claim 1, wherein said engaging groove is substantially cylindrical and parallel to the rear wall.

3. The card connector according to claim 2, wherein said engaging groove defines an upper exposed opening, and wherein a width of the opening of the engaging groove is narrower than a diameter of the engaging groove

4. The card connector according to claim 1, wherein said cover comprises a top cover and a bottom cover, the receptacle being defined between the top and bottom covers.

5. The card connector according to claim 4, wherein the bottom cover defines a opening for engaging with the base member, the conductive contacts upwardly project into the receptacle through the opening to electrically connect with the electrical card, and the blades extend downwardly from the bottom cover and are adjacent to a rear portion of the gap.

6. The card connector according to claim 1, wherein the pivoting portion extends between the pinholes and has a same axis as the pinholes.

7. The card connector according to claim 1, wherein each conductive contact includes a contact terminal, a retaining terminal and a compression spring interposed between the contact terminal and retaining terminal.

8. The card connector according to claim 7, wherein said retaining terminal includes a pair of symmetrical fixing beams extending upwardly from a base portion thereof, and wherein the insulative housing defines a pair of fixing slots adjacent to two sides of the insulative housing.

9. The card connector according to claim 7, wherein said contact terminal defines a receiving cavity for receiving an upper end of the compression spring, and wherein the retaining terminal includes a base portion defining a hollow space for receiving a lower end of the compression spring.

10. The card connector according to claim 9, wherein said insulative housing includes a plurality of through holes through the top and bottom walls for receiving the conductive contacts.

11. A card connector assembly comprising:
a base member including an insulative rectangular housing and a plurality of conductive contacts disposed in the housing, said housing defining am upward mating face and a rear wall, a pivoting portion extending from the rear wall;
a metallic cover defining a pair of upper and lower plates with a space therebetween, at least one pivotal section formed on a rear portion of the metallic cover, the lower plate defining an opening, said pivotal section being essentially located below the lower plate when the cover is in a locked position and axially aligned with the pivotal portion in a lateral direction so that the cover is pivotal relative to the base member about an axial axis, along said lateral direction, defined by said pivotal section and said pivotal portion; and
an IC card being inserted into the space; wherein
when said cover is pivotally moved toward the base member in the closed position, the lower plate is directly seated upon the upward mating face, and the contacts extend above the upward mating face through the opening and engaged with the IC card.

12. The card connector assembly according to claim 11, wherein said cover further includes an engaging device to lock to the base member when said cover is in the locked position.

13. The card connector assembly according to claim 12, wherein said engaging device is located below the lower plate when said cover is in the locked position.

14. A card connector assembly comprising:
a base member including an insulative rectangular housing and a plurality of conductive contacts disposed in the housing, said housing defining am upward mating face and a rear wall, a pivoting portion extending from the rear wall;
a metallic cover defining a space therein, at least one pivotal section formed on a rear portion of the metallic cover, said pivotal section and including a pair of opposite vertical blades along a front-to-back direction and being essentially located below a lower plate thereof when said cover is in a locked position, and axially aligned with the pivotal portion along a transverse direction perpendicular to said front-to-back direction so that the cover is pivotal relative to the base member about an axial axis, along said transverse direction, defined by said pivotal section and said pivotal portion; and
an IC card being inserted into the space; wherein
when said cover is pivotally moved toward the base member in a closed position, the lower plate is directly seated upon the upward mating face.

15. The card connector assembly according to claim 14, wherein said cover further includes a pair of engaging sheets locked to the housing and located below the lower plate when said cover is in the locked position.
